(19) United States
(12) Patent Application Publication
(10) Pub. No.: US 2026/0246834 A1
(43) Pub. Date: Aug. 20, 2026

(54) Digital Content Distribution System

(71) Applicant: Tommy Tienda, Pueblo, CA (US)

(72) Inventor: Tommy Tienda, Pueblo, CA (US)

(21) Appl. No.: 19/372,852

(22) Filed: Oct. 29, 2025

Related U.S. Application Data
(60) Provisional application No. 63/759,606, filed on Feb. 18, 2025.

(51) Int. Cl. H04L 67/1097; G06K 7/14; G06Q 10/083; G06Q 20/08

(52) U.S. Cl. CPC H04L 67/1097; G06K 7/1417; G06Q 10/083; G06Q 20/0855

(57) ABSTRACT

A system and method for digital content distribution is disclosed. The system includes a front-end interface and a backend server connected via a communication network. Upon receiving a digital item request via a text-based or form-based input, a message processing engine identifies matching content using natural language processing or keyword mapping. A payment gateway generates a unique, secure payment link, which is shared with the user through messaging services. Upon confirmation of payment, a digital delivery module transmits a download or a viewing link for the requested content. The system supports a variety of formats including eBooks, music, videos, and documents, and may optionally trigger the shipment of physical media. An alternate method enables users to tap a request button that opens a messaging app with a pre-formatted request, streamlining digital content acquisition using native device capabilities.

### CROSS REFERENCE TO RELATED APPLICATION

The present application claims priority to, and the benefit of, U.S. Provisional Application No. 63/759,606 which was filed on Feb. 18, 2025 and is incorporated herein by reference in its entirety.

### FIELD OF THE INVENTION

The present invention generally relates to the field of digital media distribution. More specifically, the present invention relates to a streamlined digital content acquisition system configured to provide users with instant, secure access to eBooks and other digital media via mobile and web platforms. The system includes an easy to use interface through which users can submit content requests, and a backend infrastructure processes the requests, generating secure payment links, and delivering digital items immediately upon transaction completion. The invention is designed to accommodate various content types, device formats, and user preferences. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, many individuals enjoy reading but often face challenges in obtaining physical books, particularly paperback and hardcover editions. Traditional book purchasing methods such as through physical bookstores or online retailers can be cost-prohibitive for many users. The retail prices of physical books are often elevated by additional costs such as printing, distribution, and inventory management. Moreover, online book orders typically require multiple days or even weeks for delivery, creating delays that discourage timely access to reading material.

In addition to time constraints, shipping costs associated with physical book purchases can be considerable, especially for international deliveries or expedited shipping options. The added expenses further deter users from purchasing books online, particularly when they are seeking immediate access to specific titles. Accordingly, individuals desire a more efficient, cost-effective, and instant method of acquiring books and other digital media.

Therefore, there exists a long-felt need in the art for a digital content distribution system that overcomes the limitations of traditional physical book purchasing models. There is a long-felt need for a method that enables readers to obtain books, music, videos, and other digital media instantly. There is also a long-felt need for a system that provides equitable access to reading material and media for users. Furthermore, there is a long-felt need for a content delivery solution that reduces environmental impact by eliminating the need for paper, packaging, and freight transportation associated with traditional book distribution. Also, there is a long-felt need in the art for a system that enables users to text the service with a specific book title for purchase. Finally, there is a long-felt need in the art for a content distribution system that makes all the ordered information accessible online securely.

The subject matter disclosed and claimed herein, in one embodiment, comprises a streamlined digital content distribution system accessible via a mobile application and/or web portal. The system enables users to submit simple text-based requests for specific books or digital media titles, which are then processed by a backend server. The server interprets the request, matches it to a digital content database, and generates a secure, unique payment link for the requested item. Upon payment confirmation, the system immediately delivers a viewing or download link to the user's device via SMS, email, or in-app notification. The system supports multiple content formats, including eBooks, audio, video, documents, and images, and is compatible with smartphones, tablets, laptops, and other electronic computing devices.

In this manner, the system of the present invention satisfies the long-felt need for a fast, accessible, and cost-effective alternative to physical book ordering. The present invention provides users with a software application or website that enables the purchase and delivery of digital versions of books through a convenient text message-based interface. The system enables users to simply text the title of a specific book to the service in order to initiate a purchase. Upon receiving the request, the system generates and transmits a secure payment portal link to the user. Once payment is completed, the system instantly delivers a link to access the digital version of the book, which can be opened and read on a smartphone, tablet, or other electronic device. This process eliminates the need for users to purchase or wait for physical copies of books, thereby offering instant access to reading material. Furthermore, the system is adaptable for transmitting additional forms of digital media including music, songs, audio files, artwork, images, documents, and other web-accessible information via smartphone.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a digital content distribution system comprising a front-end interface including a software application accessible on an electronic computing device and a web portal accessible via a browser-based client. A backend server includes a message processing engine configured to receive a request for a digital item submitted via the software application or web portal, and to interpret the request using natural language processing or keyword mapping. A content database stores a plurality of digital items, wherein the message processing engine is further configured to match the request to a corresponding digital item in the content database. A payment gateway is configured to generate a secure, unique payment link associated with the requested digital item and to process a payment transaction. A digital delivery module is configured to, upon confirmation of the payment, generate and transmit a download or viewing link for the requested digital item to the electronic computing device via a messaging channel.

In another aspect, a computer-implemented method for fulfilling a digital media request is disclosed. The computer-implemented method comprises receiving, via a front-end interface of a software application or web portal, a user request comprising a keyword or title of a desired digital item, processing the request using natural language processing or keyword matching to identify a matching digital item from a content database, generating a unique payment link associated with the requested digital item, transmitting the payment link to the user through a messaging service or in-app communication, receiving confirmation of payment, and generating and sharing a download or viewing link that enables access to the requested digital item on the user's device.

In another embodiment, a method for initiating a digital item request via a messaging interface is described. The method includes the steps of receiving a user tap or click on a digital item request button in a mobile application, automatically opening a messaging application on the user's device with a recipient address and a pre-formatted message containing the digital item title, transmitting the message to a backend server, matching the title in the message to a digital item stored in a content database, generating a payment link and sending it to the user, and upon payment confirmation, delivering a link for accessing the digital item through a digital channel.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of digital content distribution system of the present invention in accordance with the disclosed structure;

FIG. 2 illustrates a flow chart depicting a process of processing and fulfilling a digital item request submitted by a user, in accordance with an embodiment of the present invention;

FIG. 3 illustrates an exemplary user interface displayed by the application or web portal for enabling users to initiate the purchase of a digital book or other digital media item in accordance with one embodiment of the present invention;

FIG. 4 illustrates an exemplary payment interface displayed by the application and the portal in accordance with one embodiment of the present invention;

FIG. 5 illustrates an exemplary post-purchase delivery interface displayed on the user's device in accordance with one embodiment of the present invention;

FIG. 6 illustrates an exemplary user interface of a media library screen in accordance with one embodiment of the present invention; and

FIG. 7 illustrates a flowchart depicting an automated message initiation process used in the system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a digital content distribution system that overcomes the limitations of traditional physical book purchasing models. There is a long-felt need for a method that enables readers to obtain books, music, videos, and other digital media instantly. There is also a long-felt need for a system that provides equitable access to reading material and media for users. Furthermore, there is a long-felt need for a content delivery solution that reduces environmental impact by eliminating the need for paper, packaging, and freight transportation associated with traditional book distribution. Also, there is a long-felt need in the art for a system that enables users to text the service with a specific book title for purchase. Finally, there is a long-felt need in the art for a content distribution system that makes all the ordered information accessible online securely.

The present invention, in one exemplary embodiment, is a computer-implemented method for fulfilling a digital media request. The computer-implemented method comprises receiving, via a front-end interface of a software application or web portal, a user request comprising a keyword or title of a desired digital item, processing the request using natural language processing or keyword matching to identify a matching digital item from a content database, generating a unique payment link associated with the requested digital item, transmitting the payment link to the user through a messaging service or in-app communication, receiving confirmation of payment, and generating and sharing a download or viewing link that enables access to the requested digital item on the user's device.

Reference will now be made in detail to the present preferred embodiments of the invention, examples of which are illustrated in the accompanying drawings. Wherever possible, the same reference numerals are used in the drawings and the description to refer to the same or like parts.

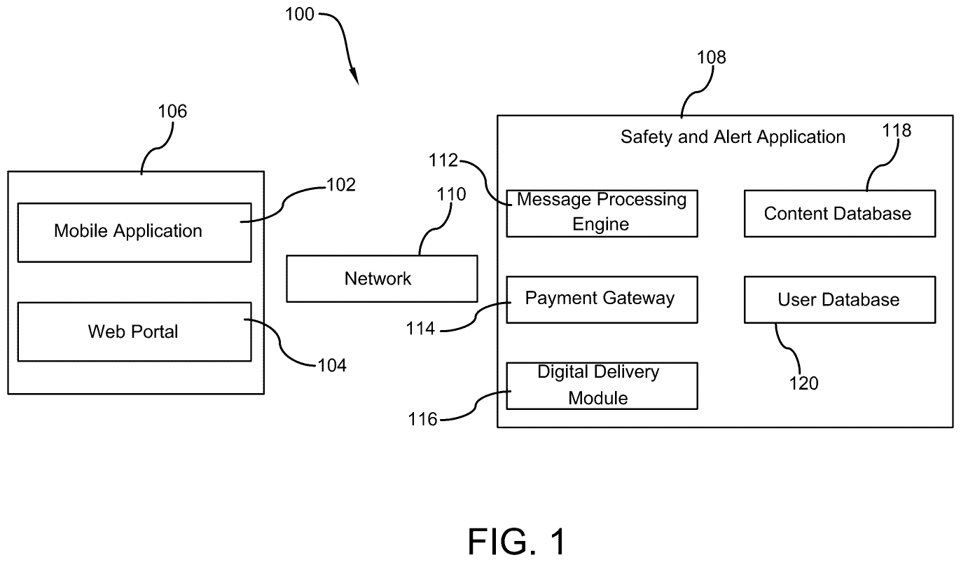

Referring initially to the drawings, FIG. 1 illustrates a schematic view of digital content distribution system of the present invention in accordance with the disclosed structure. The digital content distribution system 100 of the present invention is designed to enable streamlined digital content acquisition and delivery via mobile or web-based interaction, particularly through a text-based query model. More specifically, the content distribution system 100 includes a software application 102 and/or a web portal 104, both can be accessed using an electronic computing device 106. The application 102 and the web portal 104 enable users to access the functionality such as input book or media titles, view available content (i.e., content database), receive payment links, and access previously purchased materials, offered by the system 100. A network 110 enables communication between the application 102 and the web portal 104 with the backend server 108. The server 108 is configured for processing user requests, managing transactions, and delivering digital content to users.

The server 108 includes a message processing engine 112 which receives incoming requests containing book or media titles from users. The engine 112 parses and interprets message content using natural language processing or keyword matching and maps text entries to corresponding entries in a content database 118. A payment gateway 114 is configured to generate a unique payment link associated with a requested media and processes payment transactions securely using third-party APIs such as Stripe, PayPal, or integrated banking interfaces. The payment gateway 114 also triggers delivery of the requested digital item.

A digital delivery module 116 is configured to generate and deliver digital content links upon payment verification. The digital delivery module 116 supports various content formats such as eBooks (PDF, ePub), Music files (MP3), Videos (MP4), Documents (DOCX, TXT), Art and images (JPEG, PNG), and many more. Further, the digital delivery module 116 can also send the link through a messaging channel such as SMS/MMS, e-mail, in-app notifications, and more.

A content database 118 stores various digital assets available for purchase and delivery. It should be noted that in some embodiments, the server 108 can be connected to different 3^{rd} party content sources for delivering digital items/content to requesting users. The content database 118 is organized and indexed for efficient search and retrieval. Further, metadata information such as title, author, format, file size, DRM protection status, and more are also stored in the content database 118 for easy searching and retrieval.

A user database 120 stores user profile information, preferences, purchase history, and device information. The system 100 uses the user database 120 for tracking historical purchases of a user to provide personalized content recommendations.

The communication network 110 may be associated with an application layer for implementation of communication protocols based on one or more communication requests from the user device 106 and the server system 108. The communication data may be transmitted or received via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof. Further, the electronic computing device 106 can be any handheld computing device such as a smartphone, wearable device, laptop, and more.

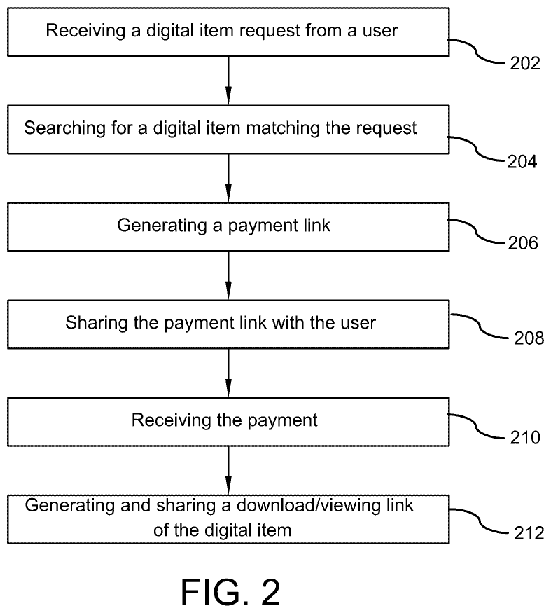

FIG. 2 illustrates a flow chart depicting a process of processing and fulfilling a digital item request submitted by a user, in accordance with an embodiment of the present invention. Initially, the system 100 receives a request for a digital item from a user and the request is preferably originated from a request control offered by the application 102 and the web portal 104 (Step 202). The request may include a keyword or exact title identifying the desired item, such as a book, music file, video, image, or document.

Then, the server 108 initiates a search operation to locate the digital item in the content database that matches the user's request (Step 204). The step 204 may include Natural language processing (NLP) to parse text of the user request and keyword mapping. If no match is found, the system may search on 3^{rd} party sources or databases or may return an appropriate message to the user.

Upon identifying a valid match, the server 108 generates a unique payment link for the requested digital item (Step 206). The link is associated with a secure transaction session and may identify the requesting user, the digital item ID. In the preferred embodiment, the link may be configured to expire after a set time or number of uses for security purposes.

Thereafter, the server 108 transmits the generated payment link back to the user (Step 208) and the communication may occur through an in-app notification, Web UI update, text message, or any other conventional communication means. The link is used as a prompt for the user to complete the payment.

In the step 210, the system monitors the payment gateway for a transaction confirmation and upon receiving the confirmation, the user's request is validated and a record of the transaction is stored in the user database. In the final step, the system generates a download or viewing link that enables the user to access the purchased digital item (Step 212). The link may launch the content in-app for streaming or reading and can be used to trigger shipment of a physical medium (e.g., SD card), where requested by the user.

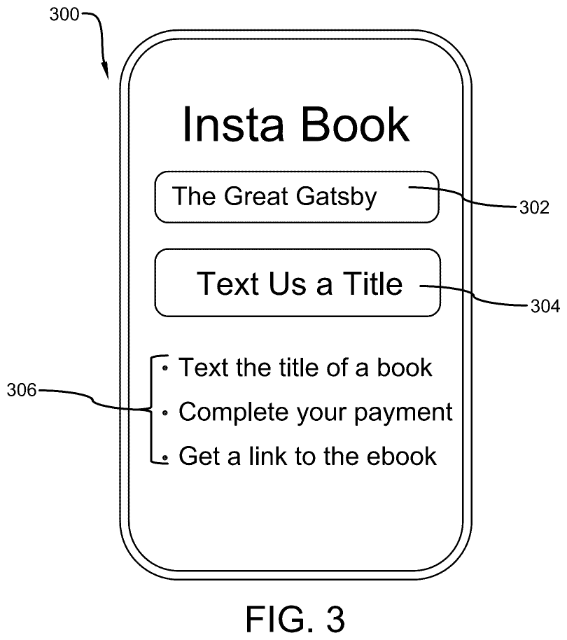

FIG. 3 illustrates an exemplary user interface displayed by the application or web portal for enabling users to initiate the purchase of a digital book or other digital media item in accordance with one embodiment of the present invention. The interface 300 displays a user input field 302 wherein the user may type the name of a book or digital item to request. The input field 302 is connected to the system's message processing engine 112 (FIG. 1) that interprets the request and searches for matching content. It should be noted that the input field 302 may include auto-complete, title suggestions, or dropdown recommendations.

An action button 304, exemplary labeled “Text Us a Title” is displayed and when tapped or pressed, sends the content of the input field 302 to the server 108. When the action button 304 is tapped, an in-app messaging feature may be activated or in some embodiments, the native SMS app with the input pre-filled in the user device 104 in which the application 102 is installed is opened. An instructional section 306 displays a plurality of instructions to help onboard new users in using the system 100. The section 306 may also be dynamic and can show different steps for different types of content (e.g., music, videos).

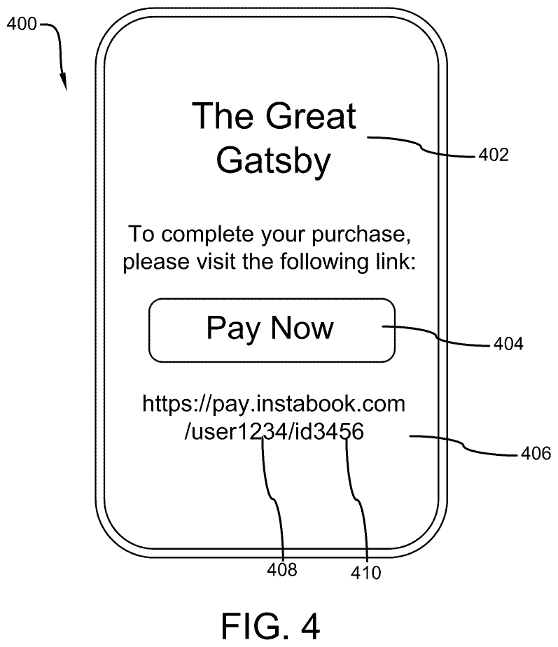

FIG. 4 illustrates an exemplary payment interface displayed by the application and the portal in accordance with one embodiment of the present invention. The user interface 400 follows the user's submission of a content request (e.g., book title) as illustrated in FIG. 3 and provides the mechanism for completing a secure transaction to obtain the requested digital item. A title field 402 conforming the identity of the requested item (e.g. The Great Gatsby) is displayed to prevent purchase errors. A payment button 404 shown exemplary as “Pay Now”, when activated, initiates the transaction process using integrated services such as Stripe, PayPal, or a custom gateway. Further, the payment gateway 114 tracks the transaction session specific to the user and the digital item ID.

A dynamic payment link 406 displays the actual unique payment URL generated by the server 108. The link 406 is encoded with a user identifier 408 and a transaction identifier 410 and can be reviewed by the user. It should be noted that both the link 406 and button 404 are time-sensitive and may be expired after a predetermined time period or a minimum number of clicks.

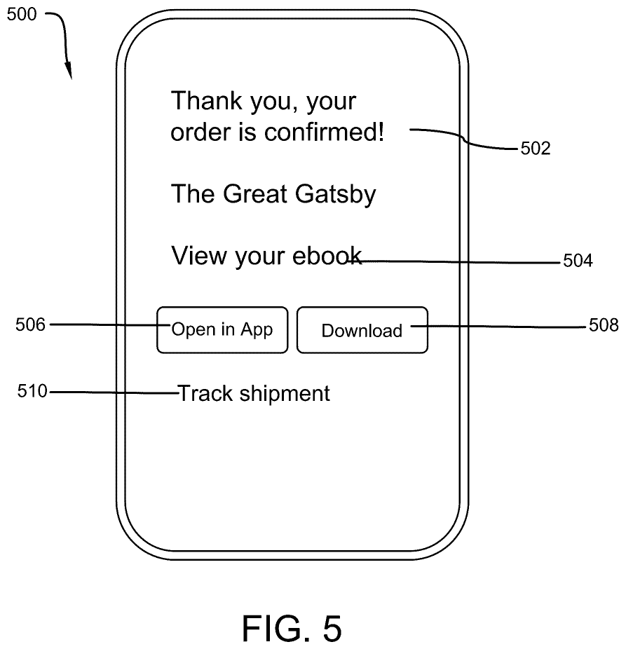

FIG. 5 illustrates an exemplary post-purchase delivery interface displayed on the user's device in accordance with one embodiment of the present invention. The interface 500 displays a confirmation message 502 and is presented immediately after the payment is successfully processed by the system (FIG. 2, step 210). The message 502 may also include date and time of purchase, transaction ID, and name of the purchase digital item.

A hyperlinked direct access element 504 provides the user with direct access to view the purchased digital content in a web viewer or mobile app interface. The element 504 may open a reader such as an HTML5-based reader for books, launch a streaming player for music/video, or may integrate with external viewers if needed.

A couple of interactive buttons 506, 508 are provided wherein the first button 506 provides an integrated reading or viewing experience within the application 102. The application 102 may support offline access. The second button 508 initiates a secure download of the digital file (e.g., ePub, PDF, MP3, MP4) directly to the user's device. The download may be DRM-protected or encrypted for content security. A track shipment link 510 connects the user to a tracking page showing delivery status, estimated arrival time, and carrier information of shipping of an SD card containing the purchased content. In some embodiments, the content is displayed on a single device and for adaptability, in some embodiments, the content can be displayed on a plurality of devices connected to a user profile.

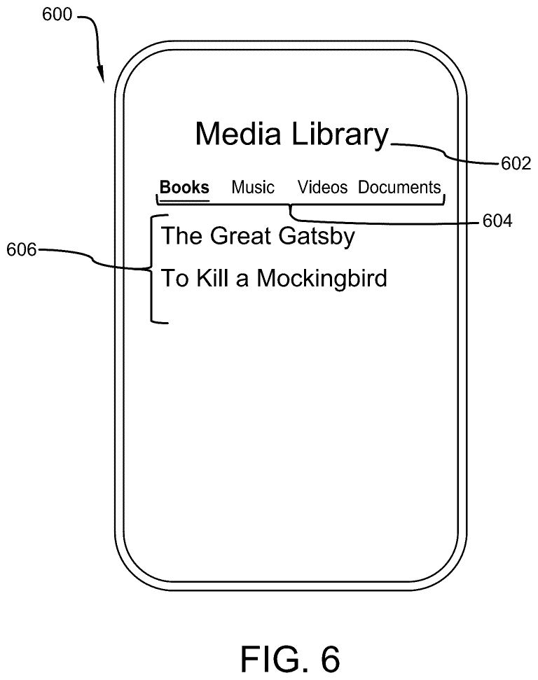

FIG. 6 illustrates an exemplary user interface of a media library screen in accordance with one embodiment of the present invention. The interface 600 enables a user to browse, access, and manage their previously purchased or downloaded digital content across multiple categories such as books, music, videos, and documents. The interface 600 displays the Media Library element 602 to indicate the purpose of the interface and provides a centralized access point for all types of digital content owned or accessed by the user. A plurality of categories 604 such as books, music, and more are displayed and enable users to navigate between different types of media. A content database area 606 displays a list of the user's digital items under the currently selected category.

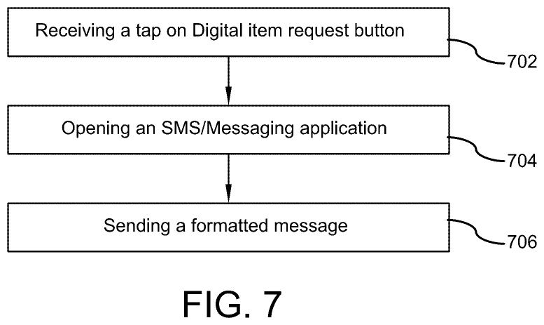

FIG. 7 illustrates a flowchart depicting an automated message initiation process used in the system in accordance with the disclosed architecture. Initially, the system receives a tap or click on a digital item request button (Step 702). Then, an SMS application or any other messaging service is automatically opened (Step 704). The opening can be achieved through a deep link and a recipient and message format is automatically created. Finally, the formatted request message is sent for processing of the request (Step 706).

In yet another embodiment, a classroom or public speaking arrangement can include a teacher/speaker preparing a written outline containing topics and main points to teach to a classroom of students, or to an audience. The prepared outline is utilized to present the talk, speech, and/or lesson. At the conclusion of the presentation, the teacher/speaker can offer a code number or QR code to the audience. The audience then can text the code number to a proprietary phone number or scan the QR code to be directed to a payment portal and/or webpage link. The teacher's/speaker's outline and notes used in the speech/lesson can be texted to recipients of the audience that texted the code number or scanned the QR code. This enables the audience to listen to the speech/lesson without the distraction of taking contemporaneous notes. In addition, the teacher/speaker now has an accumulated list of recipients that can receive future updates of the outline, thereby bringing information up to date. Those recipients of the original outline can click on a later received link to have the updated material made available to them.

It should be noted that the present invention enables one-step media requests through text or button tap and offers real-time content delivery. Further, the system is designed for mobile-first interaction with low user effort and is expandable to all digital content types.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “digital content distribution system”, “content distribution system”, and “system” are interchangeable and refer to the digital content distribution system 100 of the present invention.

Notwithstanding the forgoing, the digital content distribution system 100 of the present invention can be of any suitable configuration as is known in the art without affecting the overall concept of the invention, provided that it accomplishes the above stated objectives. One of ordinary skill in the art will appreciate that the digital content distribution system 100 as shown in the FIGS. are for illustrative purposes only, and that many other configurations of the digital content distribution system 100 are well within the scope of the present disclosure. Although the dimensions of the digital content distribution system 100 are important design parameters for user convenience, the digital content distribution system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A digital content distribution system comprising:
a mobile application;
an electronic computing device;
a communication network;
a server;
a payment gateway; and
a digital delivery module;
wherein said mobile application is configured to access functionality of said digital content distribution system;
wherein said functionality selected from the group consisting of accessing a book title, a media title, a content database, a payment link, and a previous purchase;
wherein said communication network having a communication link between said mobile application and said server;
wherein said server processes incoming user requests, manages transactions, and delivers digital content to a plurality of users;
wherein said server having a message processing engine for receiving said incoming user requests selected from the group consisting of said book title, said media title, said content database, said payment link, and said previous purchase from said plurality of users;
wherein said message processing engine parses said digital content using one or more selected from the group consisting of natural language processing, keyword matching, and text entry mapping to correspond said incoming requests with said content database;
wherein said payment gateway generates said payment link with a third-party API selected from the group consisting of a Stripe, a PayPal, and an integrated banking interface;
wherein said digital delivery module generates said digital content;
wherein said digital delivery module supports formats of said digital content selected from the group consisting of eBooks, MP3 music files, MP4 video files, JPEG images, and PNG images;
wherein said content database stores said digital content; and
further wherein said digital content in said content database having metadata information selected from the group consisting of a title, an author, a format, a file size, and a DRM protection status.

2. The digital content distribution system of claim 1 further comprising a user database for storing information selected from the group consisting of user profile information, user preferences, user purchase history, and user device information.

3. The digital content distribution system of claim 2, wherein said communication network having a communication protocol selected from the group consisting of Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), and Long Term Evolution (LTE) communication protocols.

4. A method for distributing digital content, the method comprising the steps of:
providing a digital content distribution system having a mobile application, an electronic computing device, a communication network, a server, a payment gateway, and a digital delivery module;
accessing functionality of said digital content distribution system with said mobile application, wherein said functionality selected from the group consisting of accessing a book title, a media title, a content database, a payment link, and a previous purchase, wherein said communication network having a communication link between said mobile application and said server;
processing incoming user requests with said server to manage transactions and deliver digital content to a plurality of users, wherein said server having a message processing engine for receiving said incoming user requests selected from the group consisting of said book title, said media title, said content database, said payment link, and said previous purchase from said plurality of users;
parsing said digital content with said message processing engine using one or more selected from the group consisting of natural language processing, keyword matching, and text entry mapping to correspond said incoming requests with said content database;
generating said digital content with said digital delivery module;
storing said digital content in said content database;
searching said content database with said incoming request;
locating said digital content in said content database that matches said incoming request;
generating said payment link for said incoming request;
transmitting said payment link to the user;
completing a payment through said payment link; and
generating a download link of said digital content.

5. The method for distributing digital content of claim 4, wherein said download link accesses said digital content selected from the access group consisting of a viewing link, a scanning of a QR code, an in-app streaming of said digital content, and a shipment of a physical medium.

6. The method for distributing digital content of claim 5, wherein said digital content in said content database having metadata information selected from the group consisting of a title, an author, a format, a file size, and a DRM protection status.

7. The method for distributing digital content of claim 6, wherein said payment gateway generates said payment link with a third-party API selected from the group consisting of a Stripe, a PayPal, and an integrated banking interface.

8. The method for distributing digital content of claim 7, wherein said digital delivery module supports formats of said digital content selected from the group consisting of eBooks, MP3 music files, MP4 video files, JPEG images, and PNG images.

9. The method for distributing digital content of claim 8 further providing a user database for storing information selected from the group consisting of user profile information, user preferences, user purchase history, and user device information.

10. The method for distributing digital content of claim 9, wherein said communication network having a communication protocol selected from the group consisting of Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), and Long Term Evolution (LTE) communication protocols.

11. The method for distributing digital content of claim 5, wherein said content database is a 3^{rd} party database.

12. The method for distributing digital content of claim 5, wherein said shipment of a physical medium comprises an SD card.

13. The method for distributing digital content of claim 7 further comprising the step of expiring said payment link after a predetermined time period.

14. A method for distributing digital content, the method comprising the steps of:
providing a digital content distribution system having a mobile application, an electronic computing device, a communication network, a server, a payment gateway, and a digital delivery module;
accessing functionality of said digital content distribution system with said mobile application, wherein said functionality selected from the group consisting of accessing a book title, a media title, a content database, a payment link, and a previous purchase, wherein said communication network having a communication link between said mobile application and said server;
texting user requests to said digital content distribution system, wherein said server having a message processing engine for receiving incoming said user requests selected from the group consisting of said book title, said media title, said content database, said payment link, and said previous purchase from said plurality of users;
processing incoming said user requests with said server to manage transactions and deliver digital content to a plurality of users,
parsing said digital content with said message processing engine using one or more selected from the group consisting of natural language processing, keyword matching, and text entry mapping to correspond said incoming requests with said content database;
generating said digital content with said digital delivery module;
storing said digital content in said content database;
searching said content database with said incoming request;
locating said digital content in said content database that matches said incoming request;
generating said payment link for said incoming request;
transmitting said payment link to the user;
completing a payment through said payment link;
generating a download link of said digital content, wherein said content database is a 3^{rd} party database; and
accessing said digital content selected from the access group consisting of a viewing link, an in-app streaming of said digital content, and a shipment of a physical medium, wherein said shipment of a physical medium comprises an SD card.

15. The method for distributing digital content of claim 14, wherein said digital content in said content database having metadata information selected from the group consisting of a title, an author, a format, a file size, and a DRM protection status.

16. The method for distributing digital content of claim 15, wherein said payment gateway generates said payment link with a third-party API selected from the group consisting of a Stripe, a PayPal, and an integrated banking interface.

17. The method for distributing digital content of claim 16, wherein said digital delivery module supports formats of said digital content selected from the group consisting of eBooks, MP3 music files, MP4 video files, JPEG images, and PNG images.

18. The method for distributing digital content of claim 17 further providing a user database for storing information selected from the group consisting of user profile information, user preferences, user purchase history, and user device information.

19. The method for distributing digital content of claim 18, wherein said communication network having a communication protocol selected from the group consisting of Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), and Long Term Evolution (LTE) communication protocols.

20. The method for distributing digital content of claim 16 further comprising the step of expiring said payment link after a predetermined time period.
